(19) United States
(12) Patent Application Publication
(10) Pub. No.: US 2005/0074615 A1
(43) Pub. Date: Apr. 7, 2005

(54) Polymeric crosslinkable compositions containing acetal amides

(76) Inventors: Douglas J. Adelman, Wilmington (DE); Robert John Barsotti, Franklinville, NJ (US); Patrick Henry Corcoran, Cherry Hill, NJ (US); Neville Everton Drysdale, Newark, NJ (US); Kenneth H. Leavell, Media, PA (US); Christian Peter Lenges, Wilmington (DE); Laura Ann Lewin, Greenville, NJ (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/816,601

(22) Filed: Apr. 2, 2004

Related U.S. Application Data
(60) Provisional application No. 60/460,318, filed on Apr. 4, 2003.

(51) Int. Cl. B05D 1/40; B32B 27/00

(52) U.S. Cl. 428/411.1; 524/501; 427/331

(57) ABSTRACT

Polymeric compositions containing amide acetal groups are crosslinked by hydrolyzing the amide acetal groups, and the hydroxyl groups and/or the amines functions that are formed are reacted to crosslink the composition.

### FIELD OF THE INVENTION

Described in this invention are polymeric compositions containing amide acetal groups, which are crosslinked by hydrolyzing the amide acetal groups, and subsequently reacting the hydroxyl groups and/or the amine functions that are formed to crosslink the composition.

### TECHNICAL BACKGROUND

The crosslinking (curing) of polymers is an important commercial activity, useful, for example, in elastomers, in coatings, and in thermoset materials such as are used for electronics. Controlling when and under what conditions crosslinking takes place is usually critical since once a polymer is crosslinked it is usually not “workable,” that is it may not be reshaped. In some applications, such as coatings and electronic applications it may be desirable or even mandatory that no lower molecular weight compounds be volatilized during or after the crosslinking of the polymers, so as not to contaminate sensitive equipment such as electronics, and/or to pollute the environment, as in the case of coatings.

Numerous ways have been found to avoid the production of volatile compounds during curing. For example, the reaction of epoxy groups with other groups such as hydroxyl groups may accomplish this result, but it is sometimes difficult to control after the ingredients are mixed. Furthermore, higher temperatures may be required for this operation. To avoid these types of problems, especially in coatings which often must be cured under conditions close to ambient conditions and which often must be stable for long periods before curing, other solutions have been found, such as the use of spiroorthoesters, see for example World Patent Application 9731073. However new and/or improved methods of crosslinking polymers are needed.

For coatings, basecoat-clearcoat systems have found wide acceptance in the past decade as automotive finishes. Continuing effort has been directed to such coating systems to improve the overall appearance, the clarity of the topcoat, and the resistance to deterioration. Further effort has been directed to the development of coating compositions having low volatile organic content (VOC). A continuing need exists for coating formulations which provide outstanding performance characteristics after application.

In repairing damage, such as dents to auto bodies, the original coating in and around the damaged area is typically sanded or ground out by mechanical means. Some times the original coating is stripped off from a portion or off the entire auto body to expose the bare metal underneath. After repairing the damage, the repaired surface is coated, preferably with low VOC coating compositions, typically in portable or permanent low cost painting enclosures, vented to atmosphere to remove the organic solvents from the freshly applied paint coatings in an environmentally safe manner. Typically, the drying and curing of the freshly applied paint takes place within these enclosures. Furthermore, the foregoing drying and curing steps take place within the enclosure to also prevent the wet paint from collecting dirt or other contaminants in the air.

As these paint enclosures take up significant floor space of typical small auto body paint repair shops, these shops prefer to dry and cure these paints as fast as possible. More expensive enclosures are frequently provided with heat sources, such as conventional heat lamps located inside the enclosure to cure the freshly applied paint at accelerated rates. Therefore, to provide more cost effective utilization of shop floor space and to minimize fire hazards resulting from wet coatings from solvent based coating compositions, there exists a continuing need for low VOC fast curing coating formulations which cure under ambient conditions while still providing outstanding performance characteristics.

Amide acetals have been used for example in copolymerization with polyisocyanates as disclosed in U.S. Pat. No. 4,721,767. However, none of the references describe the crosslinking of amide acetal containing compositions via hydrolysis of the amide acetal groups. This invention provides amide acetal based coating compositions which dry and cure rapidly without the potential problems created by VOC emissions.

### SUMMARY OF THE INVENTION

This invention concerns a first composition, comprising,
(a) (i) a first polymer having at least one intact amide acetal group attached to a molecule of said first polymer;
   (ii) a crosslinking agent containing first functional groups which react with hydroxyl or secondary amine groups, provided that said crosslinking agent has an average of at least two first functional groups per molecule of said crosslinking agent;
   (iii) optionally at least one solvent; and
   (iv) optionally at least one catalyst for the reaction of said hydroxyl groups or secondary amines with said first functional groups; and at least one second catalyst for hydrolysis of said amide acetal groups; and
(b) (i) a second polymer having second functional groups which react with hydroxyl or secondary amine groups, provided that said second polymer has an average of at least two second functional groups per molecule of said second polymer;
   (ii) a compound containing at least one intact amide acetal group;
   (iii) optionally at least one solvent; and
   (iv) optionally at least one first catalyst for the reaction of said hydroxyl groups or secondary amines with said second functional groups; and at least one second catalyst for hydrolysis of said amide acetal groups.

Also disclosed herein is a second composition, comprising,
(a) (i) a first polymer having at least one intact amide acetal group attached to a molecule of said first polymer;
   (ii) a crosslinking agent containing first functional groups which react with hydroxyl groups or secondary amines, provided that said crosslinking agent has an average of at least two first functional groups per molecule of said crosslinking agent;
   (iii) water; and
   (iv) optionally at least one or more solvent;
   (v) optionally at least one first catalyst for the reaction of said hydroxyl groups or secondary amines with said first functional groups; and optionally at least one second catalyst for hydrolysis of said amide acetal groups; and
(b) (i) a second polymer having second functional groups which react with hydroxyl groups or secondary amines, provided that said second polymer has an average of at least two second functional groups per molecule of said second polymer;
   (ii) a compound containing at least one intact amide acetal group;
   (iii) water; and
   (iv) optionally at least one or more solvent;
   (v) optionally at least one first catalyst for the reaction of said hydroxyl groups or secondary amines with said first functional groups; and optionally at least one second catalyst for hydrolysis of said amide acetal groups.

Also described herein is a first process for the crosslinking of a polymeric composition, comprising, exposing said polymeric composition in the uncrosslinked form to water to crosslink said polymeric composition, provided that said polymeric composition comprises,
(a) (i) a first polymer having at least one intact amide acetal group attached to said first polymer;
   (ii) a crosslinking agent containing first functional groups which react with hydroxyl groups or secondary amines, provided that said crosslinking agent has an average of at least two first functional groups per molecule of said crosslinking agent; and
   (iii) optionally at least one solvent; and
   (iv) optionally at least one catalyst for the reaction of said hydroxyl groups or secondary amines with said first functional groups; and at least one second catalyst for hydrolysis of said amide acetal groups; and
(b) (i) a second polymer having second functional groups which react with hydroxyl groups or secondary amines, provided that said second polymer has an average of at least two second functional groups per molecule of said second polymer;
   (ii) a compound containing at least one intact amide acetal group;
   (iii) optionally at least one solvent; and
   (iv) at least one first catalyst for the reaction of said hydroxyl groups or secondary amines with said second functional groups; and at least one second catalyst for hydrolysis of said amide acetal groups.

This invention also involves a second process for forming a crosslinked coating, comprising,
(A) applying a polymeric coating composition to a substrate in an uncrosslinked form;
(B) exposing said polymeric coating composition in an uncrosslinked form to water; and
(C) allowing said polymeric coating composition in an uncrosslinked form to crosslink, provided that said polymeric composition comprises,
   (a) (i) a first polymer having at least one intact amide acetal group attached to said first polymer;
      (ii) a crosslinking agent containing first functional groups which react with hydroxyl groups or secondary amines, provided that said crosslinking agent has an average of at least two first functional groups per molecule of said crosslinking agent; and
      (iv) optionally at least one or more solvent;
      (v) optionally at least one first catalyst for the reaction of said hydroxyl groups or secondary amines with said first functional groups; and optionally at least one second catalyst for hydrolysis of said amide acetal groups; and
   (b) (i) a second polymer having second functional groups which react with hydroxyl groups or secondary amines, provided that said second polymer has an average of at least two second functional groups per molecule of said second polymer;
      (ii) a compound containing at least one intact amide acetal group; and
      (iii) optionally at least one or more solvent;
      (iv) optionally at least one first catalyst for the reaction of said hydroxyl groups or secondary amines with said first functional groups; and optionally at least one second catalyst for hydrolysis of said amide acetal groups.

### DETAILED DESCRIPTION OF THE INVENTION

By polymers herein are meant those entities with number average molecular weight from about 100 to about 100,000. Preferably, the number average molecular weight of the polymers is from about 100 to about 3000.

By oligomers herein is meant those polymers which have a number average molecular weight less than about 3000.

By an amide acetal group herein is meant a group of the formula 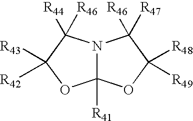
wherein R₄₁-R₄₉ independently represent a hydrogen, C₁-C₂₀ alkyl, C₁-C₂₀ alkenyl, C₁-C₂₀ alkynyl, C₁-C₂₀ aryl, C₁-C₂₀ alkyl ester, or C₁-C₂₀ aralkyl group, said alkyl, alkenyl, alkynyl, aryl, or aralkyl may each have one or more substituents selected from the groups consisting of halo, alkoxy, nitro, amino, alkylamino, dialkylamino, cyano, alkoxy silane and amide acetal (difunctional) and carbamoyl.

By an intact amide acetal group is meant that the two rings of the spiro group are still present, at least before any desired reaction such as hydrolysis takes place.

The amide acetals can be made by the reaction of an appropriate dialcoholamine (not including, for example, any other hydroxyalkyl groups which may also be present in the “diol”) with nitriles as shown in the reaction below with sodium based catalyst:

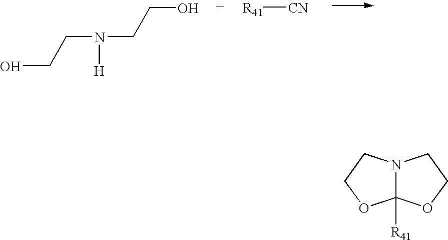

Alternatively, amide acetals can also be produced by reaction of dialcoholamides with dialkylcarbonates as shown, by way of example, in the reaction below:

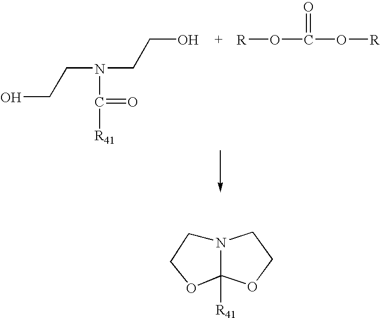

In the crosslinkable compositions herein, amide acetals groups are present in some form (see below), and the crosslinking reaction can be initiated when water comes in contact with these groups to hydrolyze them. By water is meant water in the pure form, moisture, moist air, moist gas or mixture of gases, or any other aqueous or non-aqueous media in which water may be present in a homogeneous or a heterogeneous mixture. Such media may be in the liquid form or the gaseous form.

When the amide acetal is simply hydrolyzed, amino hydroxy ester is formed which then converts to the amide diol as illustrated below. The amino hydroxy ester and the amide diol exist simultaneously as the reaction of conversion of the amino hydroxy ester to amide diol can be controlled by time, temperature, pH, and the urethane forming catalyst present in the reaction mixture. An advantage of the amide diol is that it demonstrates minimal yellowing in the finished product, before reacting with crosslinking agent. A rapid reaction with the cross-linking agent avoids the yellowing of the amine functionality in the product. Both of these hydrolyzed products are cross-linking agents because of the presence of their dual reactive side. In the case of the amino hydroxy ester the reactive sites are the secondary amine and the hydroxyl groups. In the case of the amide diol the reactive groups are the hydroxyls or diol:

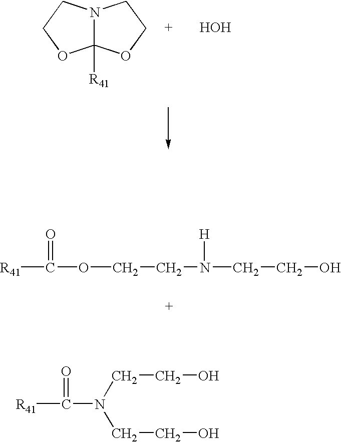

Note that in this reaction, no relatively volatile low molecular weight products are produced. Since these reactions may be acid catalyzed some of the ring opening of the amide acetal may lead to cationic polymerization rather than simple ring opening. Herein preferably the major molar portion of the amide acetal present may simply ring open and do not polymerize, more preferably at least about 75 mole percent, and especially preferably at least 90 molar percent may simply ring open and do not polymerize. The polymerization occurs generally at high temperatures.

In the first and second compositions herein, and in the materials used in the first and second processes, in (a)(i) and (b)(ii) the amide acetal groups may be included by a variety of methods. In one instance [in (b)(ii)] the amide acetal may be included as a “monomeric” compound, which may hydrolyze, thus providing reactive hydroxyl groups.

Alternatively, the amide acetal groups may be part of a (possibly low molecular weight) polymer [in (a)(i)]. For example a dihydroxy amide acetal (which has not yet been hydrolyzed) may be reacted with an excess of a diisocyanate such as bis(4-isocyanatophenyl)methane (MDI), toluene diisocyanate (TDI), hexamethylene diisocyanate (HMDI) or isophorone diisocyanate (IPDI) to form an isocyanate ended “prepolymer”, which upon exposure to water undergoes hydrolysis of the amide acetal forming hydroxyl groups, which react with the remaining isocyanate groups to crosslink the polymer. Since amide acetal often hydrolyze faster than isocyanate reacts with water, this is believed to be main mode of the crosslinking reaction for this type of polymer. Other diols such as ethylene glycol or 1,4-butanediol may also be copolymerized into the (pre)polymer formed. It is noted that in this type of isocyanate containing (pre)polymer, the amide acetal group is (at least before hydrolysis) part of the main chain (not on a branch) of the polymer formed.

An example of the cross-linking agent, or second polymer with functional groups capable of reacting with hydroxyl or secondary amines, for the amide acetal is as follows: 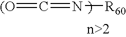
wherein R₆₀ is a hydrocarbyl structure.

Examples of suitable polyisocyanates include aromatic, aliphatic or cycloaliphatic di-, tri- or tetra-isocyanates, including polyisocyanates having isocyanurate structural units, such as, the isocyanurate of hexamethylene diisocyanate and isocyanurate of isophorone diisocyanate; the adduct of 2 molecules of a diisocyanate, such as, hexamethylene diisocyanate and a diol such as, ethylene glycol; uretidiones of hexamethylene diisocyanate; uretidiones of isophorone diisocyanate or isophorone diisocyanate; the adduct of trimethylol propane and meta-tetramethylxylylene diisocyanate.

Additional examples of suitable polyisocyanates include 1,2-propylene diisocyanate, trimethylene diisocyanate, tetramethylene diisocyanate, 2,3-butylene diisocyanate, hexamethylene diisocyanate, octamethylene diisocyanate, 2,2,4-trimethyl hexamethylene diisocyanate, 2,4,4-trimethyl hexamethylene diisocyanate, dodecamethylene diisocyanate, omega, omega-dipropyl ether diisocyanate, 1,3-cyclopentane diisocyanate, 1,2-cyclohexane diisocyanate, 1,4-cyclohexane diisocyanate, isophorone diisocyanate, 4-methyl-1,3-diisocyanatocyclohexane, trans-vinylidene diisocyanate, dicyclohexylmethane-4,4′-diisocyanate, 3,3′-dimethyl-dicyclohexylmethane4,4′-diisocyanate, a toluene diisocyanate, 1,3-bis(1-isocyanato1-methylethyl)benzene, 1,4-bis(1-isocyanato-1-methylethyl)benzene, 1,3-bis(isocyanatomethyl)benzene, xylene diisocyanate, 1,5-dimethyl-2,4-bis(isocyanatomethyl)benzene, 1,5-dimethyl-2,4-bis(2-isocyanatoethyl)benzene, 1,3,5-triethyl-2,4-bis(isocyanatomethyl)benzene, 4,4′-diisocyanatodiphenyl, 3,3′-dichloro-4,4′-diisocyanatodiphenyl, 3,3′-diphenyl4,4′-diisocyanatodiphenyl, 3,3′-dimethoxy4,4′-diisocyanatodiphenyl, 4,4′-diisocyanatodiphenylmethane, 3,3′-dimethyl4,4′-diisocyanatodiphenyl methane, a diisocyanatonaphthalene, polyisocyanates having isocyanaurate structural units, the adduct of 2 molecules of a diisocyanate, such as, hexamethylene diisocyanate or isophorone diisocyanate, and a diol such as ethylene glycol, the adduct of 3 molecules of hexamethylene diisocyanate and 1 molecule of water (available under the trademark Desmodur® N from Bayer Corporation of Pittsburgh, Pa.), the adduct of 1 molecule of trimethylol propane and 3 molecules of toluene diisocyanate (available under the trademark Desmodur® L from Bayer Corporation), the adduct of 1 molecule of trimethylol propane and 3 molecules of isophorone diisocyanate, compounds such as 1,3,5-triisocyanato benzene and 2,4,6-triisocyanatotoluene, and the adduct of 1 molecule of pentaerythritol and 4 molecules of toluene diisocyanate.

In (a)(i) the first polymer contains intact (before hydrolysis) amide acetal groups, and a crosslinking agent contains first functional groups which react with hydroxyl or secondary amine groups. The crosslinking agent may be a monomeric compound such as a diisocyanate such as MDI, TDI, HMDI or IPDI, or an epoxy resin, or may be a polymer containing first functional groups. For example it may be (meth)acrylate copolymer containing repeat units derived from 2-isocyanatoethyl (meth)acrylate or glycidyl (meth)acrylate. It is also possible that (a)(i) and (a)(ii) are “combined” in the same polymer, that is a single polymer acts as both (a)(i) and (a)(ii). For example one can copolymerize an amide acetal with 2-isocyanatoethyl (meth)acrylate or glycidyl (meth)acrylate and optionally other copolymerizable monomers. When that single polymer is exposed to moisture, presumably the amide acetal groups will hydrolyze forming amino hydroxy groups (which eventually convert to hydroxyl groups as shown previously), which in turn will react with the isocyanate, carboxylic acid anhydride, melamine, silane(s) or epoxide groups, whichever are present. This (a)(i) and (a)(ii) and may be combined as a single polymer or may be more than one substance.

In a similar manner, (b)(ii) may be a monomeric compound containing one or more amide acetal groups, more preferably one amide acetal group.

In one preferred embodiment of this invention, the second polymer which has second functional groups capable of reacting with hydroxyl or secondary amines has a number average molecular weight less than 3000. A preferred functionality for this second polymer is isocyanate.

A specific example of the cross-linking agent, or second polymer with functional groups capable of reacting with hydroxyl or secondary amines, used here is the Desmodur® 3300 compound from Bayer. The idealized structure of Desmodur® 3300 is given as follows (also, pentamer, heptamer and higher molecular weight species can be present):

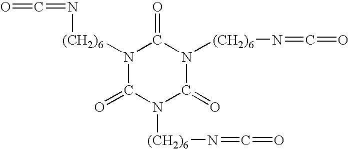

The amide acetal may also be present in the polymer as part of a branch. For example, a monohydroxyl amide acetal may be converted to a (meth)acrylate ester by esterification and the resulting (meth)acrylic ester, 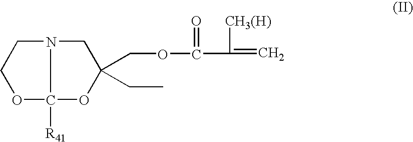
may be free radically copolymerized with other free radically copolymerizable monomers such as (meth)acrylates and styrenes. Analogous variations will be obvious to the skilled artisan.

Also present in these compositions, as (a)(ii) or (b)(i), and the processes in which they are used is a material having a first or second functional group which reacts with hydroxyl or secondary amine groups. This reaction should take place under the conditions chosen for the crosslinking reaction. These conditions may be ambient conditions or heating or other conditions that may be used to prod the reaction to proceed. Preferably the reaction with hydroxyl or secondary amine groups should not produce any volatile low molecular weight compounds, except those normally found in air (CO₂, water, etc.) Typical groups which react with hydroxyl or secondary amine groups include isocyanates (including isocyanurate trimers), epoxides, carboxylic acid anhydrides (especially those which are parts of polymers), melamine, and silane(s). Isocyanates, melamine and silane are especially preferred for coatings.

In any of the compositions herein, the polymeric materials may range from relatively low to relatively high molecular weight. It is preferred that they be of relatively low molecular weight so as to keep the viscosity of the compositions before crosslinking low, so as to avoid or minimize the need for solvent(s).

The second composition herein contains water. It is to be understood that as the water contacts the amide acetal groups present in the composition, the amide acetal groups will start to hydrolyze, eventually leading to crosslinking of the composition. This is basically what happens in the first and second process herein. The water may be introduced in a variety of ways. For example, especially in the case of a coating the water may introduced into the uncrosslinked or crosslinking (while the crosslinking is taking place) coating by absorption from the air. This is very convenient for making an uncrosslinked coating composition which is stable until exposed to (moist) air. Alternatively water may be mixed in a mixing head or spray mixing head (for a coating) just before crosslinking is to take place. This is particularly useful for making thicker crosslinked items such as electronic encapsulants where diffusion of moisture into a thicker section will take longer. The introduction of water can be at a point where the final shape of the polymeric crosslinked part can be formed before crosslinking takes place.

Other materials which may optionally be present in the compositions and processes include one or more solvents (and are meant to act only as solvents). These preferably do not contain groups such as hydroxyl or primary or secondary amino which can react with either the first or second functional groups and/or amide acetals. One or more catalysts for the hydrolysis of amide acetals may be present. These are typically Bronsted acids, but these acids should not be so strong as cause substantial cationic ring opening polymerization of the amide acetals and/or epoxides which may be present. If substantial cationic ring opening polymerization of amide acetal groups takes place, this can often lead to premature crosslinking of the composition. The same caveats may be said for any catalysts which may be present which catalyze the reaction of hydroxyl groups or the amino hydroxy groups with the first or second functional groups. What these catalysts may be will depend on what the first or second functional group(s) present are. Such catalysts are known in the art.

Some of the suitable catalysts for polyisocyanate can include one or more tin compounds, tertiary amines or a combination thereof; and one or more aforedescribed acid catalyst. Suitable tin compounds include dibutyl tin dilaurate, dibutyl tin diacetate, stannous octoate, and dibutyl tin oxide. Dibutyl tin dilaurate is preferred. Suitable tertiary amines include triethylene diamine. One commercially available catalyst that can be used is Fastcat® 4202 dibutyl tin dilaurate sold by Elf-AtoChem North America, Inc. Philadelphia, Pa. It is acknowledged that one skilled in the art could use acetic acid or such weak acids to block the activity of the catalyst.

The present compositions, and the process for making them crosslinked, are useful as encapsulants, sealants, and coatings. They are useful as coatings, especially transportation (automotive) coatings and industrial coatings. As transportation coating they are useful as both OEM (original equipment manufacturer) and automotive refinish coatings. They may also be used as primer coatings. They often cure under ambient conditions to tough hard coatings and may be used as one or both of the so-called base coat and clear coat automotive coatings. This makes them particularly useful for repainting of transportation vehicles in the field. An advantage of the present materials and processes in encapsulants and sealants is that when amide acetals are used in crosslinking reactions the resulting product does not shrink, or shrink as much as usual in a typical crosslinking reaction. This means any volume to be filled by the crosslinked material will be more reliably filled with a reduced possibility of voids being present due to shrinkage during crosslinking.

For whatever uses they are put to, the compositions, and the materials used in the processes described herein may contain other materials which are conventionally used in such uses. For example, for use as encapsulants and sealants the composition may contain fillers, pigments, and/or antioxidants.

For coatings there may be a myriad of other ingredients present, some of which are described below. In particular there may be other polymers (especially of low molecular weight, “functionalized oligomers”) which are either inert or have functional group other than those that may act as (a)(ii) or (b)(i) or may act as (a)(ii) or (b)(i) and also react with other reactive materials in the coating composition.

Representative of the functionalized oligomers that can be employed as components or potential cross-linking agents of the coatings are the following:

Acid Oligomers: The reaction product of multifunctional alcohols such as pentaerythritol, hexanediol, trimethylol propane, and the like, with cyclic monomeric anhydrides such as hexahydrophthalic anhydride, methylhexahydrophthalic anhydride, and the like.

Hydroxyl Oligomers: The above acid oligomers further reacted with monofunctional epoxies such as butylene oxide, propylene oxide, and the like.

Anhydride Oligomers: The above acid oligomers further reacted with ketene.

Silane Oligomers: The above hydroxyl oligomers further reacted with isocyanato propyltrimethoxy silane.

Epoxy Oligomers: The diglycidyl ester of cyclohexane dicarboxylic acid, such as Araldite® CY-184 from Ciba Geigy, and cycloaliphatic epoxies, such as ERL®-4221, and the like from Union Carbide.

Aldimine Oligomers: The reaction product of isobutyraldehyde with diamines such as isophorone diamine, and the like.

Ketimine Oligomers: The reaction product of methyl isobutyl ketone with diamines such as isophorone diamine.

Melamine Oligomers: Commercially available melamines such as CYMEL® 1168 from Cytec Industries, and the like.

AB-Functionalized Oligomers: Acid/hydroxyl functional oligomers made by further reacting the above acid oligomers with 50%, based on equivalents, of monofunctional epoxy such as butylene oxide or blends of the hydroxyl and acid oligomers mentioned above or any other blend depicted above.

CD-Functionalized Crosslinkers: Epoxy/hydroxyl functional crosslinkers such as the polyglycidyl ether of Sorbitol DCE-358® from Dixie Chemical or blends of the hydroxyl oligomers and epoxy crosslinkers mentioned above or any other blend as depicted above.

The compositions of this invention may additionally contain a binder of a noncyclic oligomer, i.e., one that is linear or aromatic. Such noncyclic oligomers can include, for instance, succinic anhydride- or phthalic anhydride-derived moieties in the Acid Oligomers: such as described above.

Preferred functionalized oligomers have weight average molecular weight not exceeding about 3,000 with a polydispersity not exceeding about 1.5; more preferred oligomers have molecular weight not exceeding about 2,500 and polydispersity not exceeding about 1.4; most preferred oligomers have molecular weight not exceeding about 2,200, and polydispersity not exceeding about 1.25. Typically, compositions will comprise from about 20 to about 80 weight percent of the functionalized oligomer based on the total weight of (i) and (ii) in the coating. Preferably compositions will comprise from about 30 to about 70 weight percent of the functionalized oligomer based on the total weight of (i) and (ii) in the coating. More preferably compositions will comprise from about 40 to about 60 weight percent of the functionalized oligomer based on the total weight of (i) and (ii) in the coating. Other additives also include polyaspartic esters, which are the reaction product of diamines, such as, isopherone diamine with dialkyl maleates, such as, diethyl maleate.

The coating compositions may be formulated into high solids coating systems dissolved in at least one solvent. The solvent is usually organic. Preferred solvents include aromatic hydrocarbons such as petroleum naphtha or xylenes; ketones such as methyl amyl ketone, methyl isobutyl ketone, methyl ethyl ketone or acetone; esters such as butyl acetate or hexyl acetate; and glycol ether esters such as propylene glycol monomethyl ether acetate.

The coating compositions can also contain a binder of an acrylic polymer of weight average molecular weight greater than 3,000, or a conventional polyester such as SCD®-1040 from Etna Product Inc. for improved appearance, sag resistance, flow and leveling and such. The acrylic polymer can be composed of typical monomers such as acrylates, methacrylates, styrene and the like and functional monomers such as hydroxy ethyl acrylate, glycidyl methacrylate, or gamma methacrylylpropyl trimethoxysilane and the like.

The coating compositions can also contain a binder of a dispersed acrylic component which is a polymer particle dispersed in an organic media, which particle is stabilized by what is known as steric stabilization. Hereafter, the dispersed phase or particle, sheathed by a steric barrier, will be referred to as the “macromolecular polymer” or “core”. The stabilizer forming the steric barrier, attached to this core, will be referred to as the “macromonomer chains” or “arms”.

The dispersed polymer contains about 10 to 90%, preferably 50 to 80%, by weight, based on the weight of the dispersed polymer, of a high molecular weight core having a weight average molecular weight of about 50,000 to 500,000. The preferred average particle size is 0.1 to 0.5 microns. The arms, attached to the core, make up about 10 to 90%, preferably 10 to 59%, by weight of the dispersed polymer, and have a weight average molecular weight of about 1,000 to 30,000, preferably 1,000 to 10,000. The macromolecular core of the dispersed polymer is comprised of polymerized acrylic monomer(s) optionally copolymerized with ethylenically unsaturated monomer(s). Suitable monomers include styrene, alkyl acrylate or methacrylate, ethylenically unsaturated monocarboxylic acid, and/or silane-containing monomers. Such monomers as methyl methacrylate contribute to a high Tg (glass transition temperature) dispersed polymer, whereas such “softening” monomers as butyl acrylate or 2-ethylhexylacrylate contribute to a low Tg dispersed polymer. Other optional monomers are hydroxyalkyl acrylates or methacrylates or acrylonitrile. Optionally, the macromolecular core can be crosslinked through the use of diacrylates or dimethacrylates such as allyl methacrylate or post reaction of hydroxyl moieties with polyfunctional isocyanates. The macromonomer arms attached to the core can contain polymerized monomers of alkyl methacrylate, alkyl acrylate, each having 1 to 12 carbon atoms in the alkyl group, as well as glycidyl acrylate or glycidyl methacrylate or ethylenically unsaturated monocarboxylic acid for anchoring and/or crosslinking. Typically useful hydroxy-containing monomers are hydroxy alkyl acrylates or methacrylates as described above.

The coating compositions can also contain conventional additives such as pigments, stabilizers, rheology control agents, flow agents, toughening agents and fillers. Such additional additives will, of course, depend on the intended use of the coating composition. Fillers, pigments, and other additives that would adversely effect the clarity of the cured coating will not be included if the composition is intended as a clear coating.

The coating compositions are typically applied to a substrate by conventional techniques such as spraying, electrostatic spraying, roller coating, dipping or brushing. As mentioned above atmospheric moisture may “diffuse” into the coating and cause curing, or alternatively just before the coating is applied it is mixed with an appropriate amount of water, as in a mixing spray head. Under these latter conditions it is important to apply the coating before it crosslinks. The present formulations are particularly useful as a clear coating for outdoor articles, such as automobile and other vehicle body parts. The substrate is generally prepared with a primer and or a color coat or other surface preparation prior to coating with the present compositions.

A layer of a coating composition is cured under ambient conditions in the range of 30 minutes to 24 hours, preferably in the range of 30 minutes to 3 hours to form a coating on the substrate having the desired coating properties. It is understood that the actual curing time depends upon the thickness of the applied layer and on any additional mechanical aids, such as, fans that assist in continuously flowing air over the coated substrate to accelerate the cure rate. If desired, the cure rate may be further accelerated by baking the coated substrate at temperatures generally in the range of from about 60° C. to 150° C. for a period of about 15 to 90 minutes. The foregoing baking step is particularly useful under OEM (Original Equipment Manufacture) conditions.

In the Examples and Experiments, the following abbreviations are used:
NMR—nuclear magnetic resonance imaging
RB—round-bottomed
RT—room temperature
THF—tetrahydrofuran
TLC—thin layer chromatography

### Experimental

### Experiment 1: Preparation of Amide Acetals

### EXAMPLE 1

### Preparation of 1-Aza-(3,5,7-trimethyl)-4,6-dioxabicyclo[3,3,0]octane

In an oven-dried, 2-liter flask, equipped with a stirrer and a reflux condenser, diisopropanolamine (881.69 g, 6.67 mol), acetonitrile (681.9 g, 15.86 mol) and sodium metal (16.27 g, 0.71 mol), washed free of oil with hexane, were added. The resulting mixture was heated to 80° C. for about 68 hours under a nitrogen atmosphere.

The reaction mixture was cooled to room temperature. The excess acetonitrile was removed under reduced pressure (about 5 torr to about 40 torr). Fractional vacuum-distillation of the reaction crude gave 425.59 g of product 1-aza-(3,5,7-trimethyl)4,6-dioxabicyclo[3,3,0]octane (40.89% yield), boiling at about 69° C. to about 72° C., at a vacuum of about 2.3 torr, as a mixture of isomers.

### EXAMPLE 2

### Preparation of 1-Aza-(3,7-dimethyl-5-butyl)-4,6-dioxabicyclo[3,3,0]octane

In an oven-dried, 2-liter flask equipped with a stirrer and a reflux condenser, diisopropanolamine (541.8 g, 4.07 mol), valeronitrile (850 g, 10.24 mol) and sodium metal (15.0 g, 0.65 mol), washed free of oil with hexane, were added. The resulting mixture was heated to 80° C. for about 68 hours under a nitrogen atmosphere.

The reaction mixture was cooled to room temperature. The excess valeronitrile was removed under reduced pressure (about 5 torr to about 40 torr). Fractional vacuum-distillation of the reaction crude gave 99.23 g of product 1-aza-(3,7-dimethyl-5-butyl)-4,6-dioxabicyclo[3,3,0]octane (11.8% yield), boiling at about 90° C. to about 97° C., at a vacuum of about 2.4 torr, as a mixture of isomers. NMR analyses showed the product to be slightly contaminated with a small amount of the diisopropanolamine. This material was combined with the product from a second reaction (about 100 g) which was similar in purity. Fractional vacuum-distillation of the product obtained thus yielded the desired material 1-Aza-(3,7-dimethyl-5-butyl)4,6-dioxabicyclo[3,3,0]octane, boiling at about 70° C. to about 72° C., at a vacuum of about 0.48 torr.

### EXAMPLE 3

### Preparation of 1-Aza-(5-methyl)-4,6-dioxabicyclo[3,3,0]octane

In an oven-dried glass flask, equipped with a stirrer and a reflux condenser, diethanolamine (177.0 g, 1.68 mol), acetonitrile (167.8 g, 3.90 mol) and sodium metal (0.80 g, 0.035 mol), washed free of oil with hexane, were added. The resulting mixture was heated to 80° C. for about 24 hours under nitrogen atmosphere.

Subsequently, the reaction mixture was cooled to room temperature. The excess acetonitrile was removed at reduced pressure (about 5 torr to about 40 torr). Fractional vacuum-distillation of the reaction crude gave 74.19 g of product 1-aza-(5-methyl)-4,6-dioxabicyclo[3,3,0]octane (34.14% yield), boiling at about 60° C. at a vacuum of about 5.5 torr.

### Example 4

### Preparation of 1-Aza-(5-butyl)-4,6-dioxabicyclo[3,3,0]octane

In an oven-dried flask, equipped with a stirrer and a reflux condenser, diethanolamine (187 g, 1.78 mol), valeronitrile (278.68 g, 3.36 mol) and sodium metal (2.00 g, 0.086 mol), washed free of oil with hexane, were added. The resulting mixture was heated to 80° C. for about 68 hours under nitrogen atmosphere.

Subsequently, the reaction mixture was cooled to room temperature. The excess valeronitrile was removed under reduced pressure (about 5 torr to about 40 torr). Fractional vacuum-distillation of the reaction crude gave 69.73 g of product 1-aza-(5-butyl)-4,6-dioxabicyclo[3,3,0]octane (22.91% yield), boiling at about 85° C. to about 90° C., at a vacuum of about 2.3 torr.

### EXAMPLE 5

### Preparation of 1-Aza-(3,7-dimethyl-5-n-undecyl)-4,6-dioxabicyclo[3,3,0]octane

In an oven dried flask equipped with a stirrer and a reflux condenser diisopropanolamine (292.86 g, 2.20 mol), undecyl cyanide (500 g, 2.76 mol) and sodium metal (5.41 g, 0.23 mol), washed free of oil with hexanes, were added. The resulting mixture was placed under nitrogen and heated to 100° C. for about 68 hours.

The reaction mixture was cooled to room temperature and a vacuum fractional distillation apparatus was attached. The fractional boiling between 145-156° C. at 1.00 torr was collected (185.56 g). NMRs (proton and carbon) showed this fraction to contain the desired material with a small amount of the starting material, diisopropanolamine. This fraction was again vacuum fractional distilled, affording the desired material boiling at 135-145° C. at 1-0.85 torr (168.2 g).

### EXAMPLE 6

### Preparation of 1-Aza-(5-pentanenitrile)-4,6-dioxabicyclo[3,3,0]octane

In an oven dried 1 L flask, equipped with a stirrer and a reflux condenser, diethanolamine (291.24 g, 2.77 mol), adiponitrile (300.00 g, 2.77 mol), sodium metal (4.56 g, 0.198 mol), washed free of oil with hexane, were added. The resulting mixture was heated to 100° C. for about 180 hours under a nitrogen atmosphere. Subsequently, the reaction mixture was cooled to room temperature and then followed with fractional vacuum-distillation. 172.0 g of product 1-aza-(5-pentanenitrile)4,6-dioxabicyclo[3,3,0]octane (GC/MS results shows that a total 53.77% of adiponitrile amide acetal was in the crude mixture) was obtained, boiling at about 90° C. to about 110° C., at a vacuum of about 10 millitorr.

### EXAMPLE 7

### Preparation of (1-Aza-(TVCH—CN)4,6-dioxabicyclo[3,3,0]octane) with TVCH—CN as shown below

In an oven dried 250 ml flask, equipped with a stirrer and a reflux condenser, diethanolamine(40.0 g, 0.38 mol), TVCH—CN (80.00 g, 0.42 mol), 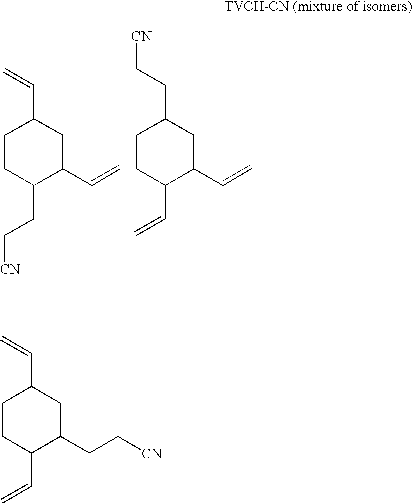
sodium metal (0.175 g, 7.6 mmol), washed free of oil with hexane, were added. The resulting mixture was heated to 100° C. for about 118 hours under a nitrogen atmosphere. Subsequently, the reaction mixture was cooled to room temperature and work up continued with fractional vacuum-distillation. 29.5 g of product (1-aza-(TVCH—CN)4,6-dioxabicyclo[3,3,0]octane) (GC/MS results show a total of 32.52%) was obtained, boiling at from about 90° C. to about 110° C., at a vacuum of about 10 millitorr.

### EXAMPLE 8

### Preparation of 1-Aza-(5-cyclooctane)-4,6-dioxabicyclo[3,3,0]octane

In an oven dried 1 L flask, equipped with a stirrer and a reflux condenser, diethanolamine (189.25 g, 1.8 mol), cyclooctane nitrile (274.0 g, 2.0 mol), sodium metal (0.92 g, 0.040 mol), washed free of oil with hexane, were added. The resulting mixture was heated to 120° C. for about 140 hours under a nitrogen atmosphere. Subsequently, the reaction mixture was cooled to room temperature and then followed with fractional vacuum-distillation. 19.7 g of product 1-aza-(5-cyclooctane)-4,6-dioxabicyclo[3,3,0]octane (conversion by GC/MS 10% of 1-aza-(5-cyclooctane)-4,6-dioxabicyclo[3,3,0]octane) was obtained, boiling at about 80° C. to about 100° C., at a vacuum of about 10 millitorr.

### EXAMPLE 9

### Preparation of 1-Aza-4,6-dioxabicyclo[3,3,0]octane product of 3,8- and 4,8-dicyanotricyclo[5.2.1.0]decane

In an oven dried 500 ml flask, equipped with a stirrer and a reflux condenser, diethanolamine (76.2 g, 0.725 mol), 3,8- and 4,8-dicyanotricyclo[5.2.1.0]decane (161.9 g, 0.869 mol), sodium metal (0.333 g, 0.0145 mol), washed free of oil with hexane, were added. The resulting mixture was heated to 110° C. for about 305 hours under a nitrogen atmosphere. Subsequently, the reaction mixture was cooled to room temperature and purified by fractional vacuum-distillation. 18.6 g of product of 3,8- and 4,8-dicyanotricyclo[5.2.1.0]decane dinitrile mono amide acetal (conversion by GC/MS 42.5% of 3,8- and 4,8-dicyanotricyclo[5.2.1.0]decane to the mono amide acetal) was obtained, boiling at about 100° C. to about 120° C., at a vacuum of about 10 millitorr.

### EXAMPLE 10

### Preparation of 1-Aza-(3-(tris-ethoxy-silyl)-propane)-4,6-dioxabicyclo[3,3,0]octane

In an oven dried 500 ml flask, equipped with a stirrer and a reflux condenser, diethanolamine (78.3 g, 0.745 mol), triethoxypropionitrile (180.0 g, 0.828 mol), sodium metal (1.17 g, 0.051 mol), washed free of oil with hexane, were added. The resulting mixture was heated to 90° C. for about 328 hrs at 100° C. under a nitrogen atmosphere. Subsequently, the reaction mixture was cooled to room temperature and then followed with petroleum ether extraction. The petroleum ether was removed in vacuo, the product was isolated via fractional vacuum-distillation. 14.1 g of product (conversion by GC/MS 35.3%) was obtained, boiling at about 90° C. to about 110° C., at a vacuum of about 10 millitorr.

### EXAMPLE 11

### Preparation of 1-Aza-4,6-dioxabicyclo[3,3,0]octane product of cyano-tricyclo[5.2.1.0]decane

In an oven dried 250 ml flask, equipped with a stirrer and a reflux condenser, diethanolamine (58.7 g, 0.558 mol), cyanotricyclo[5.2.1.0]decane (100.0 g, 0.620 mol), sodium metal (0.898 g, 0.039 mol), washed free of oil with hexane, were added. The resulting mixture was heated to 100° C. for about 141 hours under a nitrogen atmosphere. Subsequently, the reaction mixture was cooled to room temperature and then followed with fractional vacuum-distillation. 1.2 g of the 1-aza-4,6-dioxabicyclo[3,3,0]octane product of cyanotricyclo[5.2.1.0]decane were isolated (conversion by GC/MS 6.5%), boiling at about 90° C. to about 110° C., at a vacuum of about 10 millitorr.

### EXAMPLE 12

### Preparation of 1-Aza-(3-phenyl-propane)-4,6-dioxabicyclo[3,3,0]octane

In an oven dried 250 ml flask, equipped with a stirrer and a reflux condenser, diethanolamine (43.11 g, 0.410 mol), 3-phenyl-propanenitrile (59.75 g, 0.456 mol), sodium metal (0.67 g, 0.029 mol), washed free of oil with hexane, were added. The resulting mixture was heated to 90° C. for about 144 hours under a nitrogen atmosphere. Subsequently, the reaction mixture was cooled to room temperature and a mixture of product and diethanol amine separated by fractional vacuum-distillation. The product was isolated after separation from the diethanolamine phase. 32.7 g of product (conversion by GC/MS 50.8%) was obtained, boiling at about 80° C. to about 100° C., at a vacuum of about 10 millitorr.

### EXAMPLE 13

### Preparation of 1-Aza-(3-(3-cyclohexene)propane)-4,6-dioxabicyclo[3,3,0]octane

In an oven dried 50 ml flask, equipped with a stirrer and a reflux condenser, diethanolamine (11.14 g, 0.106 mol), 3-(3-cyclohexenyl)-propanenitrile (15.95 g, 0.118 mol), sodium metal (0.17 g, 7.0 mmol), washed free of oil with hexane, were added. The resulting mixture was heated to 90° C. for about 144 hours under a nitrogen atmosphere. Subsequently, the reaction mixture was cooled to room temperature and then worked up in a fractional vacuum-distillation. The product was isolated from a cut rich in diethanolamine using a separation funnel. 6.3 g of product was obtained (GC/MS analysis: 38.6%), boiling at about 80° C. to about 100° C., at a vacuum of about 10 millitorr.

### EXAMPLE 14

### Preparation of 1-Aza-(4-methyl-butanenitrile)-4,6-dioxabicyclo[3,3,0]octane (from MGN)

In an oven dried 1000 ml flask, equipped with a stirrer and a reflux condenser, diethanolamine (267.27 g, 2.54 mol), 2-methylglutaronitrile (308.27 g, 2.85 mol), sodium metal (4.09 g, 0.178 mol), washed free of oil with hexane, were added. The resulting mixture was heated to 100° C. for about 67 hours under a nitrogen atmosphere. Subsequently, the reaction mixture was cooled to room temperature and purified by fractional vacuum-distillation. 88.2 g of product 1-aza-(4-methyl-butanenitrile)-4,6-dioxabicyclo[3,3,0]octane was obtained (GC/MS analysis: 58.0%), boiling at about 90° C. to about 110° C., at a vacuum of about 10 millitorr.

### EXAMPLE 15

### Preparation of 1-Aza-(per-fluoroalkyl(C₆-C₉))-4,6-dioxabicyclo[3,3,0]octane

In an oven dried 25 ml flask, equipped with a stirrer and a reflux condenser, diethanolamine (1.0 g, 9.51 mmol), a mixture of perfluoronitriles of the general structure CF₃(CF₂)ₙCH₂CH₂CN, with n=5-13 and with 56% of the mixture having n=7, (4.8 g, 9.51 mmol), sodium metal (0.017 g, 0.75 mmol), washed free of oil with hexane, were added. The resulting mixture was heated to 100° C. for about 139 hours under a nitrogen atmosphere. Subsequently, the reaction mixture was cooled to room temperature. GC/MS results showed 34.2% of 1-aza-(per-fluoroalkyl(C₆-C₉))-4,6-dioxabicyclo[3,3,0]octane.

### EXAMPLE 16

### Preparation of bis-Aza-dioxabicyclo[3,3,0]octane derivative of adiponitrile

In an oven dried 1 L flask, equipped with a stirrer and a reflux condenser, diethanolamine (291.24 g, 2.77 mol), adiponitrile (300.00 g, 2.77 mol), sodium metal (4.56 g, 0.198 mol), washed free of oil with hexane, were added. The resulting mixture was heated to 100° C. for about 180 hours under a nitrogen atmosphere. Subsequently, the reaction mixture was cooled to room temperature and then purified by vacuum-distillation. GC/MS analysis showed 6.25% bis-aza-dioxabicyclo[3,3,0]octane.

### EXAMPLE 17

### Preparation of a Mixture of Mono, Di, Tri-(Aza-dioxabicyclo[3,3,0 octane) derived from TVCH—(CN)₃, with TVCH—(CN)₃ shown below

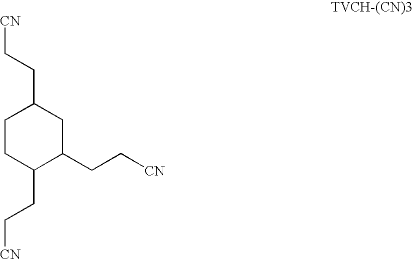

In an oven dried 250 ml flask, equipped with a stirrer and a reflux condenser, diethanolamine (129.0 g, 1.23 mol), TVCH—(CN)₃ (100.0 g, 0.41 mol), sodium metal (1.98 g, 0.086 mol), washed free of oil with hexane, were added. The resulting mixture was heated to 130° C. for about 288 hours under a nitrogen atmosphere. Subsequently, the reaction mixture was cooled to room temperature and then followed with fractional vacuum-distillation. GC/MS results shows that greater than 10% of mono, di-, tri-(aza-dioxabicyclo[3,3,0]octane) derived from TVCH(CN)₃ were obtained in the crude mixture.

### EXAMPLE 18

### Preparation of 1-Aza-(2-bicyclo[2.2.1]hept-5-ene)-4,6-dioxabicyclo[3,3,0]octane

In an oven dried 1 L round-bottom flask, equipped with a stirrer and reflux condenser, diethanolamine (2.21 mol, 235.13 g), 5-norbornene-2-carbonitrile (2.31 mol, 275.00 g), and sodium metal (0.23 mol, 5.31 g), washed free of oil with hexanes, were combined. The resulting mixture was heated to 100° C. for 180 hrs under nitrogen. Subsequently, the reaction mixture was cooled to room temperature. 1-aza-(2-bicyclo[2.2.1]hept-5-ene)-4,6-dioxabicyclo[3,3,0]octane was produced with a yield of 25% by GC/MS. Excess 5-norbornene-2-carbonitrile was removed by vacuum distillation (10 mtorr, boiling between 70-80° C.). Thereafter, a mixture of diethanolamine and the desired product was distilled. The product was extracted from diethanolamine with petroleum ether. The product was isolated after vacuo removal of the petroleum ether in 98% purity.

### EXAMPLE 19

### Preparation of 1-Aza-(3-(tris-methoxy-silyl)-Propane)-4,6-dioxabicyclo[3,3,0]octane

In an oven dried 1 L round-bottom flask, equipped with a stirrer and reflux condenser, diethanolamine (0.24 mol, 24.50 g), 2-cyanoethyltrimethoxysilane (0.29 mol, 50.00 g), and sodium metal (0.02 mol, 0.43 g), washed free of oil with hexanes, were combined. The resulting mixture was heated to 95° C. for 60 hrs under nitrogen. Subsequently, the reaction mixture was cooled to room temperature. 1-Aza-(3-(tris-methoxy-silyl)-propane)4,6-dioxabicyclo[3,3,0]octane was produced with a yield of 18% by GC/MS. 2-cyanoethyltrimethoxysilane and the product were extracted from the mixture using petroleum ether. The petroleum ether was removed in vacuo and the remainder vacuum distilled under 5 to 10 millitorr. 2-Cyanoethyltrimethoxysilane was distilled over producing the product at 89% purity.

### Experiment 2: Film Preparation

The clearcoats were drawn down over Uniprime (ED-5000), TPO (thermal polyolefin, using a 150 μm drawdown blade.

Film Hardness

The micro-hardness of the coatings was measured using a Fischerscope hardness tester (model HM100V). The tester was set for maximum force of 100 mN ramped in series of fifty, one second steps. The hardness was recorded in N/mm². The film hardness is an indication of when the coating film is ready to be buffed.

Swell Ratio

The Swell Ratio is a measure of the crosslink density of the film and the early cure properties. The Swell Ratio of the free films (removed from TPO) was determined by swelling in methylene chloride. The free film was placed between two layers of aluminum foil and using a LADD punch, a disc of about 3.5 mm diameter was punched out of the film. The aluminum foil was removed from either side of the free film. Using a microscope with 10× magnification and a filar lens the unswollen diameter (Dₒ) of the film was measured. Four drops of methylene chloride were added to the film; the film was allowed to swell for a few seconds and then a glass slide was placed over it. The swollen diameter (Dₛ) was measured. The Swell Ratio was then calculated as:
Swell Ratio=(Dₛ)²/(Dₒ)²

### Coating Formulation Examples

### EXAMPLE 1

In a glass vial, 5.08 g of Desmodur® 3300 (hexamethylene diisocyanate trimer available from Bayer; Bayer AG, Pittsburgh Pa.) and 1.75 g of 1-aza-(3,5,7-trimethyl)-4,6-dioxabicyclo[3,3,0]octane as prepared in Example 1 of Experiment 1 were added and the resulting mixture was shaken until a homogeneous solution resulted. To this solution was added dibutyl tin dilaurate (0.13 g of a 0.59M solution (propylene glycol methyl ether acetate)(PGMEA)) as a catalyst. After mixing 4-ethyl benzenesulfonic acid (0.10 g of a 1 M solution) PGMEA was added. After mixing, the resulting solution was poured on glass plates to form coatings. After 3 hours, the coatings obtained appeared tack free. After 7 days, the tack-free coating demonstrated a microhardness measurement of 149 N/mm².

### EXAMPLE 2

An aliquot of the above composition in Example 1 (4.00 g) was placed in a vial. Propylene glycol methyl ether acetate (0.45 g) was added to the vial. The solution was shaken and then poured on glass plates. After 20 hours, clear hard coatings were obtained. After 7 days, a coating having a microhardness of 142 N/mm² was obtained.

### EXAMPLE 3

5.00 g of Desmodur® 3300 (hexamethylene diisocyanate trimer available from Bayer (Bayer AG, Pittsburgh Pa.), propylene glycol methyl ether acetate (PGMEA) (0.60 g), and 1.88 g of 1-aza-(3,5,7-trimethyl)-4,6-dioxabicyclo[3,3,0]octane as prepared in Example 1 of Experiment 1 were added to a glass vial. The resulting mixture was shaken until a homogeneous solution resulted. Dibutyl tin dilaurate (0.10 g of a 0.59 M solution in (PGMEA)) was added to this solution. After mixing 4-ethylbenzenesulfonic acid (0.18 g of a 1M solution)(PGMEA) was added. After mixing, the resulting solution was poured on glass plates to form coatings. After 3 hours, the coatings were rendered tack-free. After 7 days, the free coating gave a microhardness measurement of 73 N/mm².

### EXAMPLE 4

In a glass container, 14.66 g of orthoamide of Example 1 of Experiment 1 was combined with 3.81 g of propylene glycol monomethylether acetate, 2.26 g of a 2% dibutyl tin dilaurate solution in ethyl acetate, and 1.15 g of a 10% BYK® 306 (flow additive, available from BYK-Chemie, Wallingford, Conn., in propylene glycol monomethylether acetate) solution in xylene. To this was added 38.11 g of a solution of 30.53 g of Desmodur®3300 (hexamethylene diisocyanate trimer available from Bayer (Bayer AG, Pittsburgh Pa.)) and 7.58 grams propylene glycol monomethylether acetate. This mixture was stirred and then 1.00 g of Nacure® XP-221 (a 70% solution of dodecylbenzene sulfonic acid in isopropanol, available from King Industries, Norwalk, Conn., USA) was added to the mixture and stirred. The mixture was drawn down to yield coatings of about 2 mils (about 50 μm) in thickness. These coatings were baked at 60° C. for 30 min. After 24 hours, the coating demonstrated a microhardness of 144 N/mm², and a swell ratio of 1.84.

### EXAMPLE 5

In a glass container, 11.40 g of the orthoamide of Example 1 of Experiment 1 was combined with 2.17 g of propylene glycol monomethylether acetate, 2.29 g of a 2% dibutyl tin dilaurate solution in ethyl acetate, and 1.17 g of a 10% BYK® 306 solution in xylene. To this was added 42.97 g of a solution of 18.67 g Desmodur® BA Z4470 (IPDI isocyanurate trimer; available from Bayer), 21.35 g of Desmodur® 3300 (hexamethylene diisocyanate trimer; available from Bayer) and 2.96 g propylene glycol monomethylether acetate. This mixture was stirred. 0.65 g of Nacure® XP-221 (a 70% solution of dodecylbenzene sulfonic acid in isopropanol, available from King Industries, Norwalk, Conn., USA) was added and the mixture was stirred. The mixture was drawn down to give coatings of about 2 mils (about 50 μm) in thickness. These coatings were baked at 60° C. for 30 min. After 24 hours, the coating demonstrated a micro hardness of 145 N/mm², and a swell ratio of 1.97.

### EXAMPLE 6

In a glass container, 12.02 g of the orthoamide of 1-aza-(5-pentanenitrile)-4,6-dioxabicyclo[3,3,0]octane as prepared in Example 6 of Experiment 1 was combined with 2.68 g of propylene glycol monomethylether acetate, 5.69 of a 2% dibutyl tin dilaurate solution in ethyl acetate, and 1.16 g of a 10% BYK® 306 solution in xylene. To this was added 38.46 g of a solution of 4.56 g Desmodur® BA Z4470 (IPDI isocyanurate trimer available from Bayer), 28.74 g of Desmodur® 3300 (hexamethylene diisocyanate trimer available from Bayer) and 5.16 g propylene glycol monomethylether acetate. This mixture was stirred. 0.65 g of Nacure® XP-221 (a 70% solution of dodecylbenzene sulfonic acid in isopropanol, available from King Industries, Norwalk, Conn., USA) was added and the mixture was stirred. The mixture was drawn down to give coatings of about 2 mils (about 50 μm) in thickness. These coatings were baked at 60° C. for 30 min. After 24 hours, the coating demonstrated a micro hardness of 18 N/mm², and a swell ratio of 1.65.

### EXAMPLE 7

In a glass container, 15.33 g of TVCH mono nitrile amide acetal (1-aza-(TVCH—CN)-4,6-dioxabicyclo[3,3,0]octane) as prepared in Example 7 of Experiment 1 was combined with 2.24 g of propylene glycol monomethylether acetate, 5.69 of a 2% dibutyl tin dilaurate solution in ethyl acetate, and 1.16 g of a 10% BYK® 306 solution in xylene. To this was added 35.59 g of a solution of 4.22 g Desmodur® BA Z4470 (IPDI isocyanurate trimer available from Bayer), 26.59 g of Desmodur® 3300 (hexamethylene diisocyanate trimer available from Bayer) and 4.78 g propylene glycol monomethylether acetate. This mixture was stirred. 0.65 g of Nacure® XP-221 (a 70% solution of dodecylbenzene sulfonic acid in isopropanol, available from King Industries, Norwalk, Conn., USA) was added and the mixture was stirred. The mixture was drawn down to give coatings of about 2 mils (about 50 μm) in thickness. These coatings were baked at 60° C. for 30 min. After 24 hours, the coating demonstrated a micro hardness of 72 N/mm², and a swell ratio of 1.65.

### EXAMPLE 8

In a glass container, 13.29 g of 1-aza-(5-cyclooctane)-4,6-dioxabicyclo[3,3,0]octane as prepared in Example 8 of Experiment 1 was combined with 2.70 g of propylene glycol monomethylether acetate, 5.69 of a 2% dibutyl tin dilaurate solution in ethyl acetate, and 1.16 g of a 10% BYK® 306 solution in xylene. To this was added 37.17 g of a solution of 4.41 g Desmodur® BA Z4470 (IPDI isocyanurate trimer available from Bayer), 27.77 g of Desmodur® 3300 (hexamethylene diisocyanate trimer available from Bayer) and 4.99 g propylene glycol monomethylether acetate. This mixture was stirred. 0.65 g of Nacure® XP-221 (a 70% solution of dodecylbenzene sulfonic acid in isopropanol, available from King Industries, Norwalk, Conn., USA) was added and the mixture was stirred. The mixture was drawn down to give coatings of about 2 mils (about 50 μm) in thickness. These coatings were baked at 60° C. for 30 min. After 24 hours, the coating demonstrated a micro hardness of 68 N/mm², and a swell ratio of 1.63.

1. A composition, comprising,
(a) (i) a first polymer having at least one intact amide acetal groups attached to a molecule of said first polymer;
(ii) a crosslinking agent containing first functional groups which react with hydroxyl groups or secondary amines, provided that said crosslinking agent has an average of at least two first functional groups per molecule of said crosslinking agent;
(iii) optionally at least one solvent; and
(iv) optionally at least one catalyst for the reaction of said hydroxyl groups or secondary amines with said first functional groups; and at least one second catalyst for hydrolysis of said amide acetal groups; and
(b) (i) a second polymer having second functional groups which react with hydroxyl groups or secondary amines, provided that said second polymer has an average of at least two second functional groups per molecule of said second polymer;
(ii) a compound containing at least one intact amide acetal group;
(iii) optionally at least one solvent; and
(iv) optionally at least one first catalyst for the reaction of said hydroxyl groups or secondary amines with said second functional groups; and at least one second catalyst for hydrolysis of said amide acetal groups.

2. A composition, comprising,
(a) (i) a first polymer having at least one intact amide acetal group attached to a molecule of said first polymer;
(ii) a crosslinking agent containing first functional groups which react with hydroxyl groups or secondary amines, provided that said crosslinking agent has an average of at least two first functional groups per molecule of said crosslinking agent;
(iii) water; and
(iv) optionally at least one or more solvent;
(v) optionally at least one first catalyst for the reaction of said hydroxyl groups or secondary amines with said first functional groups; and optionally at least one second catalyst for hydrolysis of said amide acetal groups; and
(b) (i) a second polymer having second functional groups which react with hydroxyl groups or secondary amines, provided that said second polymer has an average of at least two second functional groups per molecule of said second polymer;
(ii) a compound containing at least one intact amide acetal group;
(iii) water: and
(iv) optionally at least one or more solvent;
(v) optionally at least one first catalyst for the reaction of said hydroxyl groups or secondary amines with said first functional groups; and optionally at least one second catalyst for hydrolysis of said amide acetal groups.

3. A process for the crosslinking of a polymeric composition, comprising, exposing said polymeric composition in the uncrosslinked form to water to crosslink said polymeric composition, provided that said polymeric composition comprises,
(a) (i) a first polymer having at least one intact amide acetal group attached to said first polymer;
(ii) a crosslinking agent containing first functional groups which react with hydroxyl groups or secondary amines, provided that said crosslinking agent has an average of at least two first functional groups per molecule of said crosslinking agent; and
(iii) optionally at least one solvent; and
(iv) optionally at least one catalyst for the reaction of said hydroxyl groups or secondary amines with said first functional groups; and at least one second catalyst for hydrolysis of said amide acetal groups; and
(b) (i) a second polymer having second functional groups which react with hydroxyl groups or secondary amines, provided that said second polymer has an average of at least two second functional groups per molecule of said second polymer;
(ii) a compound containing at least one intact amide acetal group;
(iii) optionally at least one solvent; and
(iv) at least one first catalyst for the reaction of said hydroxyl groups or secondary amines with said second functional groups; and at least one second catalyst for hydrolysis of said amide acetal groups.

4. A process for forming a crosslinked coating, comprising,
(A) applying a polymeric coating composition to a substrate in an uncrosslinked form;
(B) exposing said polymeric coating composition in an uncrosslinked form to water; and
(C) allowing said polymeric coating composition In an uncrosslinked form to crosslink, provided that said polymeric composition comprises,
(a) (i) a first polymer having at least one intact amide acetal group attached to said first polymer;
(ii) a crosslinking agent containing first functional groups which react with hydroxyl groups or secondary amines, provided that said crosslinking agent has an average of at least two first functional groups per molecule of said crosslinking agent; and
(iii) optionally at least one or more solvent;
(iv) optionally at least one first catalyst for the reaction of said hydroxyl groups or secondary amines with said first functional groups; and optionally at least one second catalyst for hydrolysis of said amide acetal groups; and
(b) (i) a second polymer having second functional groups which react with hydroxyl groups or secondary amines, provided that said second polymer has an average of at least two second functional groups per molecule of said second polymer,
(ii) a compound containing at least one intact amide acetal group; and
(iii) optionally at least one or more solvent;
(iv) optionally at least one first catalyst for the reaction of said hydroxyl groups or secondary amines with said first functional groups; and optionally at least one second catalyst for hydrolysis of said amide acetal groups.

5. The composition as recited in claim 1 which is reacted with water to form a crosslinked polymeric material.

6. The composition as recited in claim 2 which is reacted with water to form a crosslinked polymeric material.

7. The composition as recited in claim 1 which is a coating composition.

8. The composition as recited in claim 2 which is a coating composition.

9. The coating composition as recited in claim 7 or claim 8 wherein the functional group that can react with the hydroxyl groups or the secondary amines is isocyanate.

10. The composition as recited in claim 7 or claim 8, wherein the composition further comprises additives selected from group consisting of pigments, stabilizers, rheology control agents, flow agents, toughening agents, fillers, and combinations thereof.

11. The composition as recited in claim 10, wherein the additive is a pigment.

12. The composition as recited in claim 7 or claim 8, wherein the composition further comprises materials selected from group consisting of functionalized oligomers, polyaspartic esters, binder of a noncyclic oligomer, binder of an acrylic polymer, polyester, binder of a dispersed acrylic component, and combinations thereof.

13. A substrate coated with a coating composition as recited in claim 7 or claim 8.

14. The product of the process of claim 3 which is crosslinked.

15. The product of the process of claim 4 which is crosslinked.

16. The product of claim 3 which is a coating.

17. The coating composition as recited in claim 7 or claim 8 wherein the number average molecular weight of the second polymer is less than about 3000.

18. The coating composition as recited in claim 17, wherein the second polymer has isocyanate functionality.

19. The process of claim 3 or claim 4, wherein said crosslinking agent is selected from the group consisting of silane, anhydride, melamine and epoxy.

20. The composition of claim 1 or claim 2, wherein said crosslinking agent is selected from the group consisting of silane, anhydride, melamine and epoxy.

21. The process of claim 19, wherein said crosslinking agent is melamine.

22. The composition of claim 20, wherein said crosslinking agent is melamine.

23. An amide acetal composition, comprising: 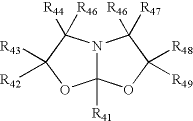
wherein R₄₁-R₄₉ independently represent a hydrogen, C₁-C₂₀ alkyl, C₁-C₂₀ alkenyl, C₁-C₂₀ alkynyl, C₁-C₂₀ aryl, C₁-C₂₀ alkyl ester, or C₁-C₂₀ aralkyl group, said alkyl, alkenyl, alkynyl, aryl, or aralkyl may each have one or more substituents selected from the groups consisting of halo, alkoxy, nitro, amino, alkylamino, dialkylamino, cyano, alkoxy silane and amide acetal (difunctional) and carbamoyl

24. The amide acetal composition of claim 23, wherein R41 represents a hydrogen, C1-C20 alkyl, C1-C20 alkenyl, C1-C20 alkynyl, C1-C20 aryl, C1-C20 alkyl ester, or C1-C20 aralkyl group, said alkyl, alkenyl, alkynyl, aryl, or aralkyl may each have one or more substituents selected from the groups consisting of halo, alkoxy, nitro, amino, alkylamino, dialkylamino, cyano, alkoxy silane and amide acetal (difunctional) and carbamoyl, and R42-R49 are each independently selected from the group consisting of hydrogen and C1-C20 alkyl.

25. The composition of claim 1 or claim 2 comprising the amide acetal of claim 23.

26. The composition of claim 1 or claim 2 comprising the amide acetal of claim 24.

27. The composition of claim 23,wherein one or more R substituents are selected from the group consisting of isocyanate, hydroxyl, methacryloxy, silane, fluoro and urethane.

28. The composition of claim 24, wherein R41 Is selected from the group consisting of isocyanate, hydroxyl, methacryloxy, silane, fluoro and urethane.

29. The composition of claim 1 or claim 2 comprising the amide acetal of claim 28.

30. The composition of claim 1 or claim 2, wherein the amide acetal has more than one functional group.

31. The composition of claim 1 or claim 2 used as a coating over a color coat in a basecoat/clearcoat system.

32. The composition of claim 1 or claim 2, wherein the compound containing at least one intact amide acetal group is 1-Aza-(3,7-dimethyl-5-undecyl)-4,6-dioxabicyclo(3.3.0)octane.
